(19) United States
(12) Patent Application Publication
(10) Pub. No.: US 2021/0370694 A1
(43) Pub. Date: Dec. 2, 2021

(54) CONTACT MEMBERS FOR SLIDABLE CARRIAGES

(71) Applicant: Hewlett-Packard Development Company, L.P., Spring, TX (US)

(72) Inventors: Bartomeu Gaya Pol, Sant Cugat del Valles (ES); Marta Ramis Llinares, Sant Cugat del Valles (ES); Niels Sanchez Van den Beuken, Sant Cugat del Valles (ES)

(73) Assignee: Hewlett-Packard Development Company, L.P., Spring, TX (US)

(21) Appl. No.: 17/258,503

(22) PCT Filed: Feb. 15, 2019
(86) PCT No.: PCT/US2019/018317

§ 371 Date: Jan. 7, 2021

(51) Int. Cl. B41J 25/00; F16C 29/04

(52) U.S. Cl. CPC B41J 25/001; F16C 2324/16; F16C 29/04

(57) ABSTRACT

A contact member for a slidable carriage comprises a pair of roller bearings mounted at a contact side of the contact member and oriented to roll along a sliding direction of the contact member, and a pivot support surface to engage a counter surface structure of the slidable carriage.

### BACKGROUND

Slidably mounted carriages can be used to displace a printhead of a printer along a guide rail and can thereby allow guided displacement of the carriage along a predefined path. A contact member can couple the carriage and the guide rail.

### BRIEF DESCRIPTION OF THE DRAWINGS

The following detailed description will best be understood with reference to the drawings, wherein:

FIG. 1 illustrates a side view of schematic contact member according to an example;

FIG. 2A illustrates a perspective view of a contact member according to an example;

FIG. 2B illustrates another perspective view of a contact member including a set of principal axes of rotation according to an example;

FIG. 3 illustrates a printer comprising a slidable carriage according to an example; and

FIG. 4 illustrates a scanning system including a contact member pivotally coupled to a carriage according to an example.

### DETAILED DESCRIPTION

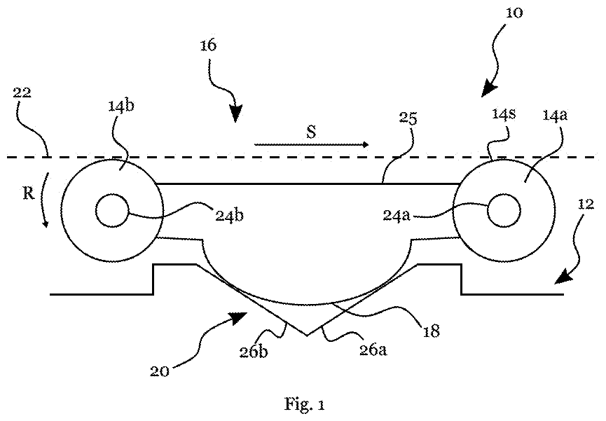

FIG. 1 illustrates a contact member 10 for a slidable carriage 12 according to an example. The contact member 10 comprises a pair of roller bearings 14a, 14b mounted on a body 25 at a contact side 16 of the contact member 10 and oriented to roll along a sliding direction S of the contact member 10. The contact member 10 further comprises a pivot support surface 18 to engage a counter surface structure 20 of the slidable carriage 12 comprising a first counter surface 26a and a second counter surface 26b. The engagement of the pivot support surface 18 and the counter surface structure 20 can provide a pivot contact thereby allowing a change of the relative orientation of the contact member 10 with respect to the carriage 12.

In some examples, the contact member 10 couples to a guide rail 22 (schematically illustrated by a dashed line) and the pair of roller bearings 14a, 14b engages the guide rail 22 at the contact side 16 of the contact member 10. For example, the contact member 10 may be biased by the carriage 12 against the guide rail 22, and the carriage 12 can be supported against the guide rail 22 with the contact member 10. When the carriage 12 is displaced along the extension of the guide rail 22, the roller bearings 14a, 14b may be rotated about their rotational axes 24a, 24b to perform a revolving motion R and limit friction between the guide rail 22 and the contact member 10. The pivot contact established by the engagement of the pivot support surface 18 and the counter surface structure 20 may mediate an alignment of the sliding direction S of the contact member 10 and the extension of the guide rail 22 during movement of the carriage 12, to counteract wear, production tolerances or misalignment between the guide rail 22 and the carriage 12.

The roller bearings 14a, 14b may comprise inner rolling elements, such as balls, cylindrical rollers, spherical rollers, tapered rollers, needle rollers, and a combination thereof, or the like to provide a low friction contact between inner and outer races of the roller bearings 14a, 14b. An outer race of the roller bearings 14a, 14b can couple to the guide rail 22 and provide a contact surface. In some examples, the roller bearings 14a, 14b are ball bearings each comprising an outer ring surface 14s defining the contact surface. The contact surface may engage with the guide rail 22 and can comprise a plastic or rubber surface or coating to mediate a contact between the guide rail 22 and the roller bearings 14a, 14b or to dampen vibrations of the contact member 10, the carriage 12 or the guide rail 22. However, other materials, such as metals, may be employed at the contact surface.

The contact member 10 may comprise a molded portion, such as a molded plastic portion, to form at least part of the body 25 of the contact member 10. The body 25 may provide a linking structure between the roller bearings 14a, 14b to establish a relative alignment and spacing of the roller bearings 14a, 14b. The pivot support surface 18 may be formed by the molded plastic portion. In some examples, the pivot support surface 18 is coated or provided with a coupling member, for example made of a metal, to reduce wear of the pivot support surface 18 during engagement with the counter surface structure 20.

In the example illustrated in FIG. 1, the pivot support surface 18 is a curved support surface 18 and rests against the first counter surface 26a and the second counter surface 26b of the counter surface structure 20 to provide a pivot contact of the contact member 10. The first and second counter surfaces 26a, 26b may form an angled (V-shaped) recess, with the pivot support surface 18 extending into the recess to locate the contact member 10 relative to the carriage 12 and to prevent relative movement of the contact member 10 with respect to the carriage 12 along the sliding direction S. However, the pivot contact can allow pivoting of the contact member 10 with respect to the carriage 12 to bring both roller bearings 14a, 14b of the pair of roller bearings 14a, 14b in contact with the guide rail 22. The contact member 10 may pivot about a pivot point of the contact member 10 arranged midways between the rotational axes 24a, 24b of the roller bearings 14a, 14b, wherein a distance of the pivot point from the curved support surface 18 may depend on the curvature of the curved support surface 18. In some examples, the carriage 12 is supported by the contact member 10 against the guide rail 22 and a normal force of the carriage 12 against the guide rail 22 maintains a contact between the pivot support surface 18 and the counter surface structure 20, wherein the pivot support surface 18 and the counter surface structure 20 may form a joint and a socket of a pivot mount, respectively. The counter surface structure 20 defining the recess can be considered to provide the socket of the pivot mount and the pivot support surface 18 can be considered to provide a joint head which engages with the socket.

As illustrated in the example of FIG. 1, the pair of roller bearings 14a, 14b can be spaced along the sliding direction S of the contact member 10, and the pivot support surface 18 can be arranged between the pair of roller bearings 14a, 14b with respect to the sliding direction S. A pivoting of the contact member 10 on the pivot support surface 18 may adjust a pitch of the contact member 10 and accordingly a respective height of the roller bearings 14a, 14b with respect to the slidable carriage 12 which may reduce an impact of irregularities of the guide rail 22. In other words, the contact member 10 may tilt to maintain a contact between the guide rail 22 and the pair of roller bearings 14a, 14b, wherein an irregularity of the surface of the guide rail 22 whose longitudinal extension (i.e. along the sliding direction S) is smaller than the spacing of the roller bearings 14a, 14b along the sliding direction S can be at least partially cancelled or averaged by the tilting of the contact member 10. The pivot point of the contact member 10 may be located midways between the roller bearings 14a, 14b , such as to provide a substantially symmetric behavior for back and forth movement of the contact member 10 along the sliding direction S. In another example, the pivot point can be located closer towards one of the roller bearings to reduce friction for a respective sliding direction. The contact side 16 is arranged opposite to the pivot support surface 18.

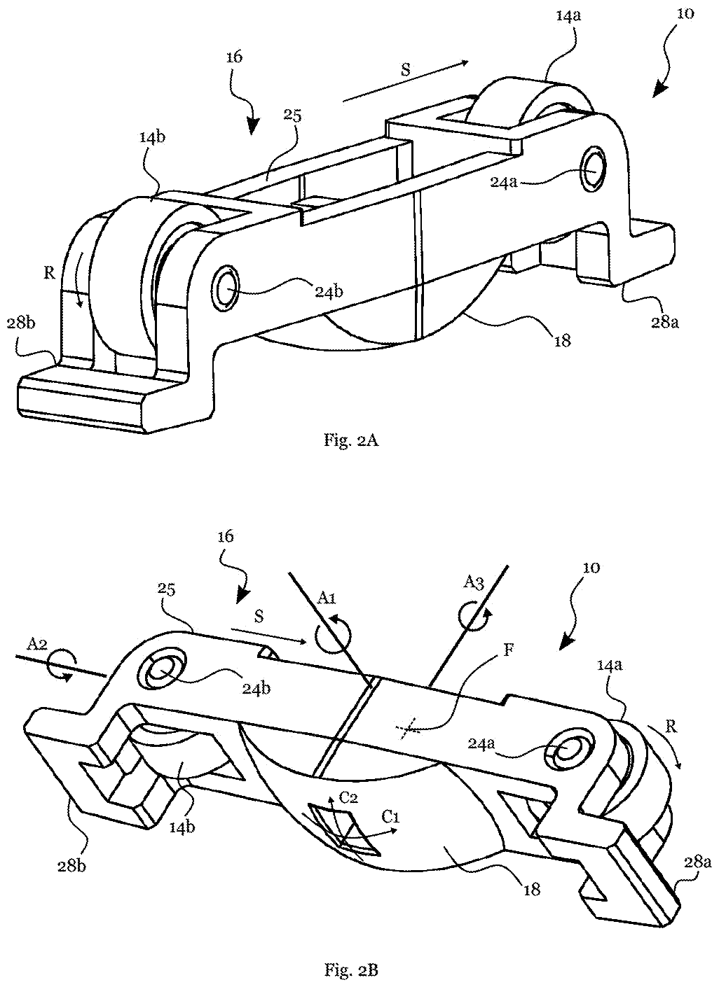

FIGS. 2A and 2B illustrate two perspective views of another example of a contact member 10 comprising a pair of roller bearings 14a, 14b mounted at a contact side 16 on a body 25 of the contact member 10 to roll in a revolving motion R along a sliding direction S. A pivot support surface 18 is arranged opposite to the contact side 16 to engage the contact member 10 with a counter surface structure 20 of a carriage 12 (not shown in FIGS. 2A, 2B). In some examples, the pair of roller bearings 14a, 14b is mounted at the contact side 16 to couple to a guide rail 22 of a scanning system extending along a scanning direction and to guide displacement of the carriage 12 along the guide rail 22.

The body 25 of the contact member 10 further comprises protruding elements 28a, 28b at opposite sides of the contact member 10 with respect to the sliding direction S of the contact member 10. The illustrated protruding elements 28a, 28b protrude along the sliding direction S to engage with corresponding brackets or end stops to limit a pivot amplitude of the contact member 10 about the pivot support surface 18. Thus, in some examples, the contact member 10 may comprise a protruding element 28a, 28b protruding along the sliding direction S to limit a pivot amplitude of the contact member 10. Instead of two, also a single protruding element 28a, or 28b may be provided.

Furthermore, the contact member 10 of FIGS. 2A, 2B is provided with a convex support surface 18 as the pivot support surface 18 to enable the pivoting of the contact member 10 about at least two axes of rotation A1, A2, A3. As an example, principal axes of rotation A1, A2, A3 of the contact member 10 are illustrated in FIG. 2B, wherein the principal axes of rotation A1, A2, A3 are depicted as having a perpendicular orientation with respect to each other.

A first axis of rotation A1 (pitch axis) can correspond to a pivoting of the contact member 10 about an axis parallel to the axes of rotation 24a, 24b of the pair of roller bearings 14a, 14b and, in an example, located midways between the axes of rotation of the roller bearings, to adjust a pitch of the roller bearings 14a, 14b. Pivoting about Axis A1 in the following is termed a rocking motion of the contact member 10.

A second axis of rotation A2 (roll axis) can be aligned with the sliding direction S to enable a rolling motion of the contact member 10 during a sliding motion S of the contact member 10. The rolling motion can adjust a relative orientation of the contact side 16 of the contact member 10 with respect to the guide rail 22, such as to compensate a misalignment of the carriage 12 and the guide rail 22 perpendicular to the sliding direction S of the contact member 10. Pivoting about Axis A2 in the following is termed a rolling motion of the contact member 10.

A third axis of rotation A3 (yaw axis) is illustrated as being normal to the contact side 16 and can enable a yawing motion of the contact member 10 during a sliding of the carriage 12 to reduce or compensate a misalignment of the scanning direction S and an orientation of the pair of roller bearings 14a, 14b of the contact member 10. Pivoting about Axis A3 in the following is termed a yawing motion of the contact member 10.

A first curvature C1 (highlighted with a curved arrow on the convex support surface 18) of the convex support surface 18 may be selected to control the rocking motion of the contact member 10, wherein a center of curvature (e.g. pivot point) associated with the first curvature C1 of the pivot support surface 18 may be located beyond a reference point F, as seen from the convex support surface 18, wherein the reference point F is one of a center of gravity of the contact member 10 and a point which lies on a line connecting the rotational axes 24a, 24b of the pair of roller bearings 14a, 14b. During movement of the contact member 10, a normal force of the trailing roller bearing 14b onto a guide rail 22 may be increased with respect to a normal force of the leading roller bearing 14a as a result of the location of the location of the center of curvature beyond the reference point F. The increased normal force of the trailing roller bearing 14b may mediate a self-alignment of the contact member 10 with respect to the guide rail 22 to compensate misalignments between the carriage 12 and the guide rail 22. The self-alignment may then stabilize an orientation of the contact member 10 during movement of the carriage 12 along the guide rail 22 to maintain a low friction contact of the carriage 12 and the guide rail 22.

A second curvature C2 of the convex support surface 18 perpendicular to the first curvature C1 may mediate the rolling motion of the contact member 10 around the second axis of rotation A2. The curvatures C1, C2 may be equal or may be different to adjust a torque for pivoting the contact member 10 about different axes of rotation A1, A2, A3. In some examples, the pivot support surface 18 comprises a spherical portion to form a spherical joint with the counter surface structure 20 of the slidable carriage 12 along at least two axes of rotation. As illustrated in FIG. 2B the pivot support surface 18 may be discontinuous and may define isolated curved contact portions to engage with a corresponding portion of a counter surface structure 20.

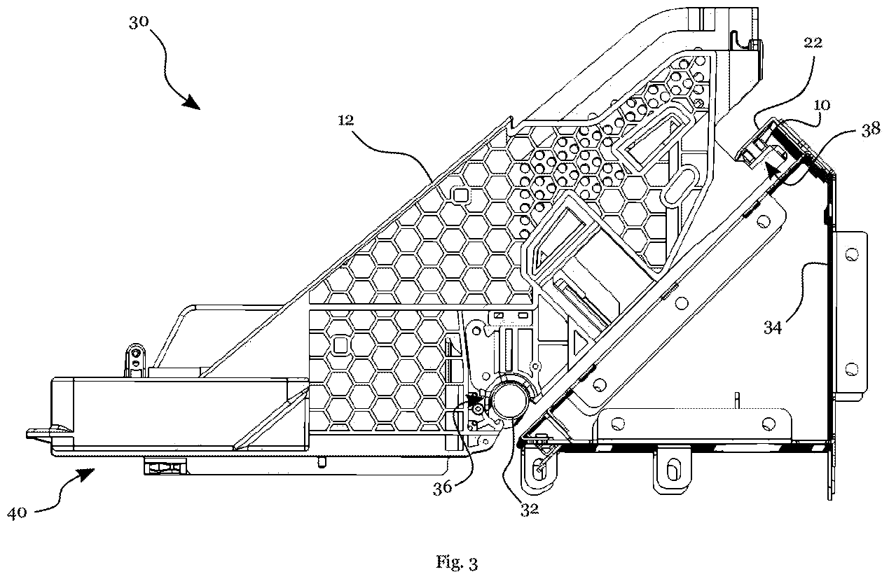

FIG. 3 illustrates a printer 30 comprising a slidable carriage 12 with a contact member 10 according to an example. The carriage 12 is coupled to a scan axis beam 32 of the printer 30 arranged along a scanning direction (oriented along the plane of projection of FIG. 3) of the printer 30. The scan axis beam 32 can be mounted on a frame 34 of the printer 30, the frame 34 featuring a guide rail 22 extending along the scanning direction of the carriage 12.

The slidable carriage 12 is slidably coupled to the scan axis beam 32 to slide along the scan axis beam 32. As illustrated in FIG. 3, the carriage 12 can be coupled with a slidable scan axis mounting 36 to control displacement along the scanning direction, wherein a low friction coupling between the scan axis beam 32 and the carriage 12 may be provided by bearings supporting the carriage on the scan axis beam 32, such as roller bearings distributed about the circumference of the scan axis beam 32, in the scan axis mounting 36 of the carriage 12. The carriage 12 may be further coupled to a belt or a rack to displace the carriage 12 along the scan axis beam 32 in a controllable manner.

In some examples, the slidable carriage 12 is to carry a printhead 40 to print on a printable medium (not shown in FIG. 3). A displacement of the carriage 12 along the scan axis beam 32 may then change the relative position of the printhead 40 with respect to the printable medium to deposit a printing fluid or a build material, or to perform a localized modification thereof. The weight of the printhead 40 can induce a torque of the carriage 12 about the scan axis beam 32. The torque can be counteracted at a mounting surface 38 of the carriage 12, wherein the mounting surface 38 may be located at a side of the carriage 12 which, relative to the scan axis beam, is opposite to the printhead 40.

The mounting surface 38 of the carriage 12 can couple to the guide rail 22 with a contact member 10 mounted on the carriage 12, the contact member 10 comprising a pair of roller bearings 14a, 14b spaced along the scanning direction at a contact side 16 of the contact member 10. The contact member 10 can slidably engage the guide rail 22 at the contact side 16 which may provide a slidable engagement of the carriage 12 spaced from the scan axis mounting 36 in a direction perpendicular to the scanning direction. Hence, the carriage 12 can be rotatably mounted on the scan axis beam 32, but the slidable engagement at the guide rail 22 prevents a rotation of the carriage 12 about the scan axis beam 32 due to a torque imposed on the carriage 12. In other words, the contact member 10 coupled to the mounting surface 38 can form an anti-rotation device for the carriage 12 and may engage with the guide rail 22 to control or prevent a rotation of the carriage 12 during the displacement of the carriage 12 along the scan axis beam 32.

The contact member 10 can be pivotally mounted on a counter surface structure 20 of the carriage 12 with a pivot support surface 18 and may thus at least partially compensate wear, production tolerances or misalignment between the guide rail 22 and the carriage 12. During displacement of the carriage 12 both bearings 14a, 14b may remain in contact with the guide rail 22. Concerning further details and movement of the contact member 10, reference is made to the description of FIG. 1, 2A and 2B wherein respective features and functionalities may be provided also in the contact member 10 of the example of FIG. 3.

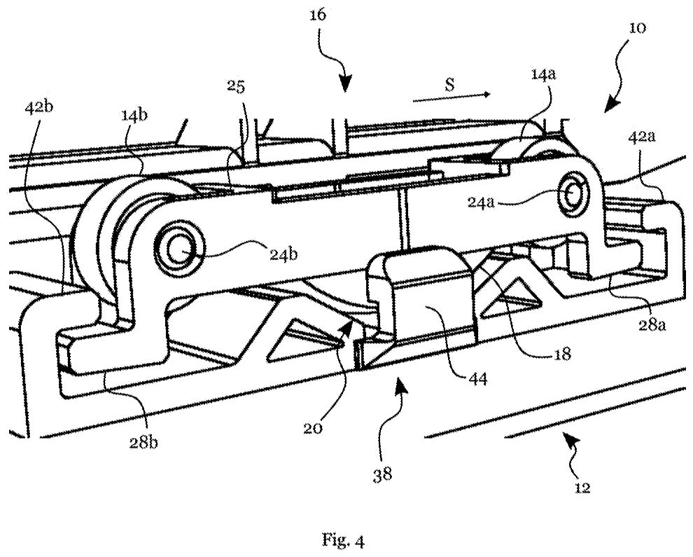

FIG. 4 illustrates an isolated view of the mounting of the contact member 10 on the carriage 12 at the mounting surface 38 according to an example. The contact member 10 may be the same as or different from the contact member 10 of FIG. 3 and comprises a pair of roller bearings 14a, 14b mounted at a contact side 16 of the contact member 10 to engage a guide rail 22 (not depicted in FIG. 4, but depicted in FIG. 3) and to roll along the scanning direction of the carriage 12, wherein the pair of roller bearings 14a, 14b are spaced along a sliding direction S of the contact member 10 which may align with the scanning direction. A pivot support surface 18 of the contact member 10 is arranged opposite to the contact side 16 to engage a counter surface structure 20 of the slidable carriage 12 to provide a pivot mounting of the contact member 10 with respect to the slidable carriage 12 to enable at least a rocking motion of the contact member 10, i.e. a pivoting of the contact member 10 along a rotational axis Al parallel to a rotational axis 24a, 24b of the pair of roller bearings 14a, 14b.

The carriage 12 may comprise first and second mounting brackets 42a, 42b on opposite sides of the counter surface structure 20 and spaced along the scanning direction of the carriage 12 to limit a pivoting and in particular a rocking motion of the contact member 10 during sliding. Additionally or alternatively, the carriage can comprise lateral brackets 44 to laterally contain the contact member 10. The lateral brackets may be formed to limit a yawing motion or a rolling motion of the contact member 10 during a sliding of the carriage 12 along the scanning direction. However, the brackets 42a, 42b, 44 may allow for a degree of play of the contact member 10 engaged with the mounting surface 38 of the carriage 38 to allow for a limited self-alignment of the contact member 10 with respect to the carriage 12 and the guide rail 22. Thus, a sliding direction S of the contact member 10 (e.g. the rolling direction of the pair of roller bearings 14a, 14b) may self-align with the scanning direction of the carriage 12 by a yawing motion of the contact member 10. Moreover, the contact side 16 may align with the guide rail 22 by a limited rolling motion or rocking motion of the contact member 10 to minimize a rolling friction of the contact member 10 on the guide rail 22. The play of the contact member 10 with respect to the mounting surface 38 of the carriage 12 for a rolling motion or yawing motion may be less than 5° or less than 2°, such as 1°. In some examples, a mounting bracket 42a, 42b, 44 for the contact member 10 is integrated with the counter surface structure 20 of the carriage 12 and provides a play for the pivot mounting of less than 5° along a pivot axis of the pivot mounting. In some examples, the play of the contact member 10 along a pivot axis of the pivot mounting is at least 0.5° or 1°. For example, the play of the contact member 10 for a yawing motion or a rolling motion is at least 0.5° or 1°. In another example, the play of the contact member 10 for a yawing motion and a rolling motion is at least 0.5° or 1°.

Thus, a scanning system may comprise a carriage 12 and a first guide beam, such as the guide rail 22 of FIG. 3, wherein the carriage 12 comprises a pivotally mounted contact member 10 to engage the first guide beam 22. The contact member 10 comprises a pair of rollers 14a, 14b at a contact side 16 of the contact member 10. The pair of rollers 14a, 14b can contact the first guide beam 22 and roll along a scanning direction of the carriage 12. A pivot support surface 18 of the contact member 10 opposite to the contact side 16 engages a counter surface structure 20 of the carriage 12, wherein the pivot support surface 18 and the counter surface structure 20 provide a pivot mounting of the contact member 10 with respect to the carriage 12.

In some examples, the scanning system further comprises a second guide beam for the carriage 12, such as the scan axis beam 32 of FIG. 3. The first guide beam 22 and the second guide beam 32 may extend along parallel directions to guide a movement of the carriage 12. The carriage 12 may be rotatably mounted on the second guide beam 32 and the contact member 10 may engage the carriage 12 with the first guide beam 22 to counter a torque of the carriage 12 about the second guide beam 32. Thus, the first guide beam 22 may control an orientation of the carriage 12 around the second guide beam 32 by limiting a rotation of the carriage 12 using the slidable contact member 10 engaging the first guide beam 22. The rollers 14a, 14b of the contact member 10 may provide a low friction contact between the carriage 12 and the first guide beam 22 during a sliding movement of the carriage 12 along the scanning system. The pivot mounting of the contact member 10 may compensate misalignments between the carriage 12 and the first guide beam 22 during a sliding movement of the carriage 12 along the second guide beam 32.

1. A contact member for a slidable carriage, the contact member comprising:
a pair of roller bearings mounted at a contact side of the contact member and oriented to roll along a sliding direction of the contact member, and
a pivot support surface to engage a counter surface structure of the slidable carriage.

2. The contact member of claim 1, wherein the pivot support surface provides a pivot contact of the contact member with the counter surface structure of the slidable carriage having a pivot axis parallel to a rotational axis of the pair of roller bearings to adjust a pitch of the contact member.

3. The contact member of claim 1, wherein the contact side is arranged opposite to the pivot support surface.

4. The contact member of claim 1, wherein the pivot support surface is a curved support surface.

5. The contact member of claim 1, wherein the pivot support surface is a convex support surface and a center of curvature associated with the pivot support surface is located beyond a reference point, as seen from the convex support surface, wherein the reference point is one of a center of gravity of the contact member and a point which lies on a line connecting the rotational axes of the pair of roller bearings.

6. The contact member of claim 1, wherein the pair of roller bearings are spaced along the sliding direction of the contact member, and wherein the pivot support surface is arranged between the pair of roller bearings with respect to the sliding direction.

7. The contact member of claim 1, wherein the pair of roller bearings comprises ball bearings each comprising an outer ring surface defining a contact surface.

8. The contact member of claim 1, wherein the pivot support surface comprises a spherical portion to form a spherical joint with the counter surface structure of the slidable carriage along at least two axes of rotation.

9. The contact member of claim 1, further comprising a protruding element protruding along the sliding direction to limit a pivot amplitude of the contact member.

10. The contact member of claim 1, wherein the pair of roller bearings are mounted at the contact side to couple to a guide rail of a scanning system extending along a scanning direction and to guide displacement of the carriage along the guide rail.

11. A printer comprising:
a scan axis beam arranged along a scanning direction of the printer;
a guide rail arranged along the scanning direction; and
a slidable carriage slidably coupled to the scan axis beam to slide along the scan axis beam and comprising a mounting surface and a contact member coupled with the mounting surface,
wherein the contact member slidably engages the guide rail, wherein the contact member comprises:
a pair of roller bearings mounted at a contact side of the contact member to engage the guide rail and to roll along the scanning direction, wherein the pair of roller bearings are spaced along a sliding direction of the contact member;
a pivot support surface opposite to the contact side to engage a counter surface structure of the slidable carriage, to provide a pivot mounting of the contact member with respect to the slidable carriage having a pivot axis parallel to a rotational axis of the pair of roller bearings to adjust a pitch of the contact member.

12. The printer of claim 11, wherein the slidable carriage is to carry a printhead to print on a printable medium.

13. A scanning system comprising a carriage and a first guide beam, wherein the carriage comprises a pivotally mounted contact member to engage the first guide beam, wherein the contact member comprises:
a pair of rollers at a contact side of the contact member, wherein the pair of rollers contact the first guide beam and roll along a scanning direction of the carriage; and
a pivot support surface opposite to the contact side and to engage a counter surface structure of the carriage, wherein the pivot support surface and the counter surface structure provide a pivot mounting of the contact member with respect to the carriage.

14. The system of claim 13, wherein the counter surface structure of the carriage forms a recess for the contact member and provides a play for the pivot mounting of less than 5° along at least one pivot axis of the pivot mounting.

15. The system of claim 13, further comprising a second guide beam for the carriage, wherein the first guide beam and the second guide beam are arranged parallel to each other to guide a movement of the carriage.
